(19) United States
(12) Patent Application Publication
(10) Pub. No.: US 2021/0065039 A1
(43) Pub. Date: Mar. 4, 2021

(54) EXPLANATIONS OF MACHINE LEARNING PREDICTIONS USING ANTI-MODELS

(71) Applicant: SAP SE, Walldorf (DE)

(72) Inventors: Srivatsan Santhanam, Bangalore (IN); Atreya Biswas, Singapore (SG)

(21) Appl. No.: 16/552,013

(22) Filed: Aug. 27, 2019

(51) Int. Cl. G06N 20/00; G06N 5/02

(52) U.S. Cl. CPC G06N 20/00; G06N 5/02

(57) ABSTRACT

Methods, systems, and computer-readable storage media for receiving user input indicating a first data point representative of output of a machine learning (ML) model, calculating a source model value based on the first data point and a second data point, calculating anti-model sub-values based on the first data point and a set of data points, providing an anti-model value based on the source model value and the anti-model sub-values, and determining a reliability of the output of the ML model based on the anti-model value.

### BACKGROUND

In general, machine learning includes training a machine learning (ML) model that receives input and provides some output. Machine learning can be used in a variety of problem spaces. Example problem spaces include classifying entities, and matching entities. Examples include, without limitation, matching questions to answers, people to products, and bank statements to invoices. In such use cases, the end user typically consumes the predictions and outputs of the ML model to make further decisions or actions.

Establishing the reliability of the ML model is integral to gaining the trust of the end user and ensuring the success and usability of the ML model as a whole. Here, reliability refers to the ability of ML models to provide reasons for their predictions. In other words, a reliable ML model must be able to explain its behavior in a way that is intuitive and palpable to the end user. However, there are several barriers to establishing trust in ML applications. For example, conventional ML models are not designed to be able to explain their predictions. Further, ML models can rely on complex data representations and are themselves parameterized by layers of matrices. Consequently, ML models can be seen as black-boxes, from which relationships between input data and the subsequent output prediction is not readily discernable.

### SUMMARY

Implementations of the present disclosure are directed to explaining predictions output by machine-learning (ML) models. More particularly, implementations of the present disclosure are directed to using anti-models to indicate reliability of predictions of ML models.

In some implementations, actions include receiving user input indicating a first data point representative of output of a ML model, calculating a source model value based on the first data point and a second data point, calculating anti-model sub-values based on the first data point and a set of data points, providing an anti-model value based on the source model value and the anti-model sub-values, and determining a reliability of the output of the ML model based on the anti-model value. Other implementations of this aspect include corresponding systems, apparatus, and computer programs, configured to perform the actions of the methods, encoded on computer storage devices.

These and other implementations can each optionally include one or more of the following features: the source model value is calculated based on a simplex having vertices including the first data point, the second data point, and a third data point; the anti-model sub-values are each calculated based on a respective simplex including the first data point, a third data point, and a respective data point in a set of data points; the set of data points is defined based on a distance between the first data point and the second data point; actions further include mapping non-linear data provided from the ML model to linear data, the linear data including the first data point, the second data point, and data points in the set of data points; determining the reliability of the output of the ML model based on the anti-model value includes indicating one of reliability and unreliability by comparing the anti-model value to a threshold value; and the ML model is indicated as reliable with respect to the first data point, if the anti-model value is at least equal to the threshold value, and the ML model is indicated as unreliable with respect to the first data point, if the anti-model value is less than the threshold value.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2A schematically depicts an example machine learning (ML) model deployment and retraining approach.

FIG. 2B schematically depicts an example ML model verification approach in accordance with implementations of the present disclosure.

FIGS. 3A-3E graphically depict use of anti-models in classifications using ML models in accordance with implementations of the present disclosure.

FIGS. 4A and 4B graphically depict use of anti-models in matching queries to targets using ML models in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to explaining predictions output by machine-learning (ML) models. More particularly, implementations of the present disclosure are directed to using anti-models to indicate reliability for predictions of ML models. Implementations can include actions of receiving user input indicating a first data point representative of output of a ML model, calculating a source model value based on the first data point and a second data point, calculating anti-model sub-values based on the first data point and a set of data points, providing an anti-model value based on the source model value and the anti-model sub-values, and determining a reliability of the output of the ML model based on the anti-model value.

To provide further context for implementations of the present disclosure, and as introduced above, machine learning can be used in a variety of problem spaces. Example problem spaces include classifying entities and matching entities. Examples include, without limitation, matching questions to answers, people to products, and bank statements to invoices. For example, electronic documents representing respective entities can be provided as input to a ML model. In some examples, a ML model classifies the electronic document. In some examples, a ML model matches electronic documents to one another. In some examples, the ML model can output a category (class) of an electronic document, or a match between electronic documents with a confidence score representing an accuracy of the predicted calss/match. However, ML models can be viewed as block boxes, where input (e.g., electronic documents) is provided, and an output (e.g., match) is provided with little insight into the reasons underlying the ML model output.

In some instances, a level of understanding of the output is provided. For example, decision trees, random forest and features, such as boosting, inherently indicate significant factors in the output and provide a trace of the path to the output decision. Consequently, the output itself may be at least inherently explained. However, such explanations only address the given output, but fail to address other potential outputs that were not selected as the output or included in the output.

More generally, insights typically include a first part that supports an existing output and a second part that looks at possible alternatives and reasoning why possible alternatives are not selected. Implementations of the present disclosure address the second part of an insight, which can be driven by user feedback or engagement at runtime. ML models themselves are not domain experts and professional end users (e.g., domain experts) are relied on for cross-validation of the ML model. These end users need trust in the system, which is possible when both types of reasoning are done: why the result output by the ML model is correct, and why other potential candidates were not provided as output.

In view of the above context, implementations of the present disclosure provide a platform for indicating reliability of predictions output by ML models. More particularly, implementations of the present disclosure are directed to using anti-models to provide an indication of reliability of predictions of ML models. As described in further detail herein, use of an anti-model addresses the question of why other possibly close matches (potential outputs) were not selected. In some implementations, an anti-model is provided based on a respective ML model (also referred to as original model, or source model). An inference of the anti-model provides insight into the output provided by the ML model. In some implementations, multiple anti-models are constructed and validated against the source model. In this manner, an interaction-based mechanism is provided at runtime (i.e., during use of the ML model). This runtime-enabled experience of explainability (inferencing) improves user trust in the outputs of the ML model.

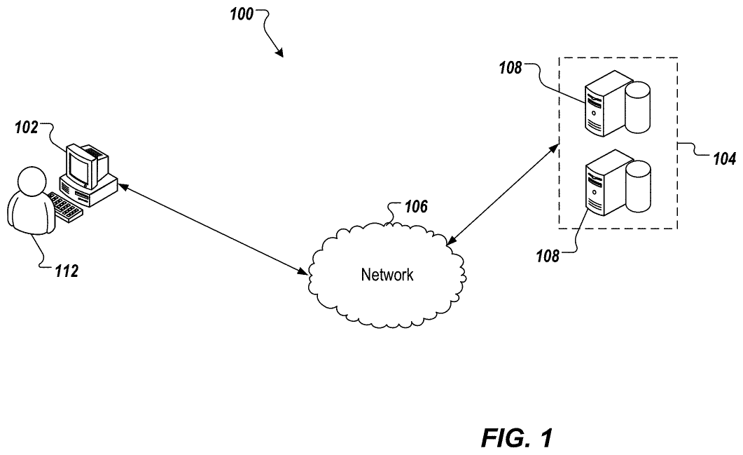

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a ML model platform that provides insight into the output provided by a ML model using one or more anti-models, as described in further detail herein. More particularly, the user 112, for example, can interact with the ML model platform during runtime of a ML model (e.g., during use of the ML model to provide output) to generate insights into the reliability of the outputs based on anti-models.

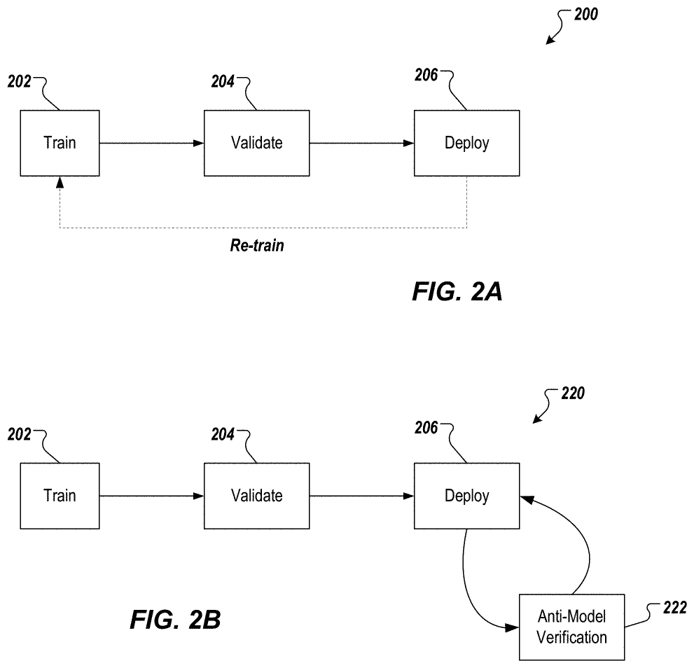

FIG. 2A schematically depicts an example ML model deployment and retraining approach 200. The example approach 200 represents a traditional ML model training and deployment cycle that includes a training phase 202, a validation phase 204, and a deploy phase 206. In the training phase 202, the ML model is trained. In the validation phase 204, the trained ML model is validated. For example, test input is provided to the trained ML model and an output of the ML model is compared to a known (or expected) output. In the deploy phase 206 (also referred to as runtime), the ML model is made available for processing input to provide output (e.g., classifications, predicted values) in a production environment.

However, in the traditional approach, there is no system-driven mechanism in place to explain to a user that consumes the output provided by the ML model results why other possibly close matches were not selected. Instead, the traditional approach implements an offline feedback mechanism for further re-training, which is both time-and resource-consuming and is not real-time. That is, a significant amount of infrastructure and compute power is required to re-train ML models along with the time delay for re-training and re-deployment.

FIG. 2B schematically depicts an example ML model verification approach 220 in accordance with implementations of the present disclosure. The example approach 220 includes the traditional ML model training and deployment cycle that includes the training phase 202, the validation phase 204, and the deploy phase 206, described above. However, instead of a re-training feedback mechanism, the example approach 220 includes an anti-model verification phase 222, described in further detail herein. In some examples, the anti-model verification phase 222 is user-triggered (e.g., is executed in response to a request issued by a user).

In accordance with implementations of the present disclosure, an anti-model is used in the anti-model verification phase 222 to provide a productive, eventful and engaging ML model verification. More particularly, the anti-model enables the results of a ML model to be introspected at runtime and enable a user to engage with the ML model to propose alternate candidate results, propose alternate hypothesis, and derive so-called anti-results. In short, the anti-model enables the user to engage with the ML system in real-time to, for example, trigger validation at runtime, engage with the ML model and understand the results of the ML model. In some implementations, and as described herein, verification using the anti-model includes the following example characteristics: anti-model (also referred to as verification model) is generated on-the-fly (i.e., during runtime), is agnostic to the type of the ML model (in other words, is source model agnostic), is light weight (relatively low computing resources are consumed by the anti-model, is executed in a separate container for fault tolerant execution (i.e., separate from a container of the ML model).

In further detail, the anti-model is generated at runtime based on a ML model that is deployed and is generating output. The anti-model is designed to fail in its output. That is, the anti-model is designed to select an output as correct, in cases where the source model did not select the output as correct. More particularly, the aim of the anti-model is to build an opposite view to an existing output of the source model. As noted above, the anti-model approach of the present disclosure is agnostic to the source model. In this manner, the interpretation provided using the anti-model is not biased towards a particular type of ML model and/or execution thereof. This agnosticism is achieved by the anti-model being based on the output of the source model, regardless of the type of the source model. Further, the anti-model of the present disclosure is lightweight in terms of computing resources required for execution, and does not require any additional or special infrastructure requirements for its execution. In some implementations, the anti-model is executed in its own container (e.g., Docker container) to provide for fault tolerance.

As described in further detail herein, the overall approach in using anti-models is based on the premise that close alternatives to a particular output are inherently found nearer to each other. If an alternative is far away from the output (and/or other alternatives), the alternative can be considered an outlier and not a practical alternative to the output. To evaluate this, implementations of the present disclosure include mapping non-linear data to a linear data set using a hyper-plane transformation. For example, with multiple dimensions, a hyperplane is used to determine a separation or distinction of non-linear mapped data points. A hyperplane can be described as a subspace of one dimension less than its ambient space. An example hyperplane transformation includes the perceptron algorithm, represented as:

h(xᵢ)=sign(w·xᵢ)

where X and W are augmented vectors and Perceptron uses hypothesis to classify data point xᵢ.

For a given data point, a set of data points is defined (e.g., based on distance from the given data point). A simplex is constructed based on the result set for the original results provided by the source model and a simplex value (SM) is provided. In some examples, a simplex can be described as a representation on a hyperplane, where the area of a simplex is a quadratic function. A set of simplices is constructed based on a selected data point. For example, a user can select a data point indicating a result that is suspect (e.g., the user may believe that the particular result is mis-classified or mis-matched). An anti-model value (ϕ) is determined based on the set of simplices and is used to evaluate the reliability of the source model. For example, if the anti-model value indicates that the anti-model succeeded, the reliability of the source model for the selected data point is in question. As another example, if the anti-model value indicates that the anti-model failed, which it is designed to do, the reliability of the source model for the selected data point is reinforced.

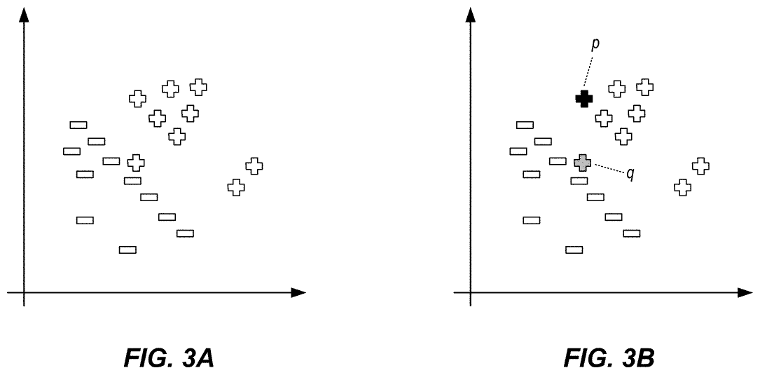

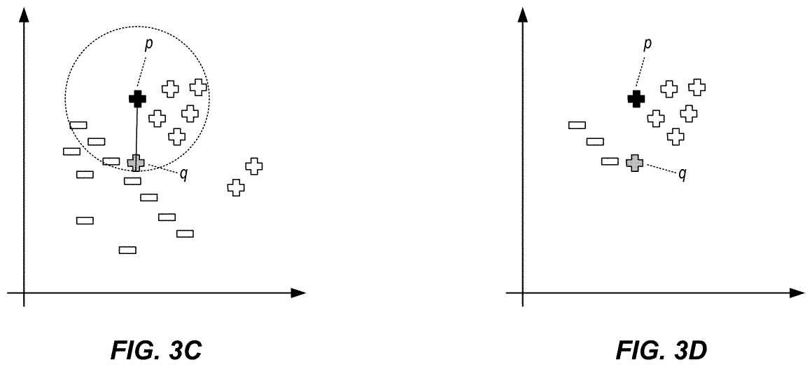

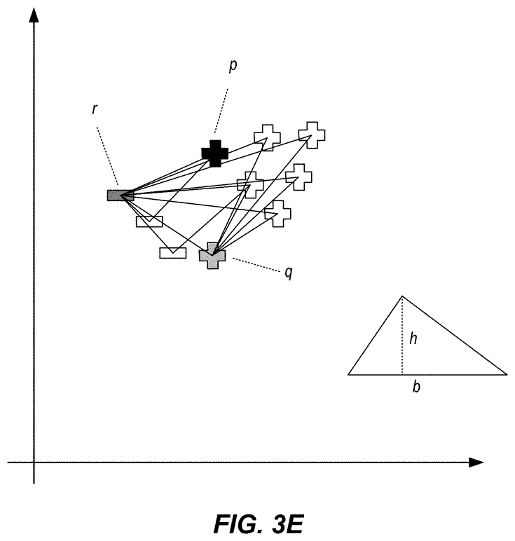

FIGS. 3A-3E graphically depict use of anti-models in classifications using ML models in accordance with implementations of the present disclosure. More particularly, FIGS. 3A-3E are based on a simple binary classification scenario, in which a ML model (source model) is to classify data points, depicted as +'s and −'s, in a given feature space. FIG. 3A graphically depicts the classification provided by the source model. In some instances, a user interacting with the source model may believe that one or more data points have been mis-classified. In accordance with implementations of the present disclosure, an anti-model can be constructed to validate the results provided by the source model.

As depicted in FIG. 3B, the user (presumably a domain expert) wants to check (at runtime) whether the classification of q is accurate. To achieve this, a clearly correctly classified data point p is selected in hand with the questionably classified data point q. An anti-model for the data point q is constructed at run-time with the hypothesis that q should be assigned the class label—(i.e., that q was mis-classified). In some examples, a set of n data points around p is defined for constructing the anti-model. As depicted in FIGS. 3C and 3D, a distance between the data point p and the data point q can be determined, and any data points within the distance are included in the set of n data points.

In some implementations, a data point is randomly selected as an anchor data point r. As depicted in FIG. 3E, a set of simplices are sequentially constructed using coordinates r, q and other data points of the set of n data points. In general, each simplex within the set of simplices is provided as a triangle (i.e., a 2-simplex) and a respective anti-model sub-value (AM) is calculated as an area of the simplex. This is represented by the following example relationship:

$${AM}_{n} = {\sum }_{i}^{n} ( {h}_{i} {b}_{i} ) / 2$$

where AMₙ is the anti-model sub-value for the data point n. For the data point p, which is a clearly correct classification, a simplex is also constructed as a triangle with the data points p, q, and r as the vertices and a respective source model value (SM) is calculated as an area of the simplex. This is represented by the following example relationship:

SM=(hᵢbᵢ)/2

where SM represents the source model value and i is the source point.

In some implementations, a function is provided based on the anti-model, which is represented by the following example relationship:

(ϕ)=fₓ(|AM₁−SM|, |AM₂−SM|, . . . , |AMₙ−SM|)

In accordance with implementations of the present disclosure, a higher value of (|AM₂−SM|) signifies that the data point q is not an mis-classified, while a lower value of (|AM₂−SM|) signifies that the data point q may be mis-classified. That is, the larger the anti-model sub-values (AM) are relative to the source model value (SM), the higher the indication is that the anti-model is not an alternative to the source model (i.e., the source model is reliable).

In some implementations, ϕ is provided as a value that indicates a likelihood that the data point q is mis-classified. In some examples, ϕ indicates whether the anti-model fails. In some examples, a threshold for acceptance of anti-model failure or non-failure is a direct correlation of confidence level expected from a ML model. This can be particular to a respective domain. For example, for a share market industry, a confidence level can be as high as 99%, while for a transportation management system used for tracking shipment and delivery, a confidence level can be 80% (as the delivery dates for large shipments need not be precisely pin-pointed. If the anti-model fails, which it is designed to do, it can be determined that the data point q is properly classified. Consequently, reliability of the source model is affirmed. On the other hand, if the anti-model does not fail, it can be determined that the data point q is mis-classified. Consequently, reliability of the source model is in doubt. This knowledge, that the specific data point q was mis-classified, can be used for targeted re-training of the ML model. For example, the user can provide feedback to a training phase that the ML model mis-classified the particular data point q.

In further detail, implementations of the present disclosure provide anti-models as real-time, interaction-based validation/substantiation of results of aML model. When an anti-model does not fail, the following is implied: more than 1 correct match or classification exists; and a classic case of mis-classification has occurred. Based on the above-example insight, the following approach to re-train and retaining learnings can be triggered: deploy a reinforcement learning mechanism (the hyper-parameter for these will be influenced by ϕ), and/or re-train with dataset having a bias to the inference discovered by the anti-model.

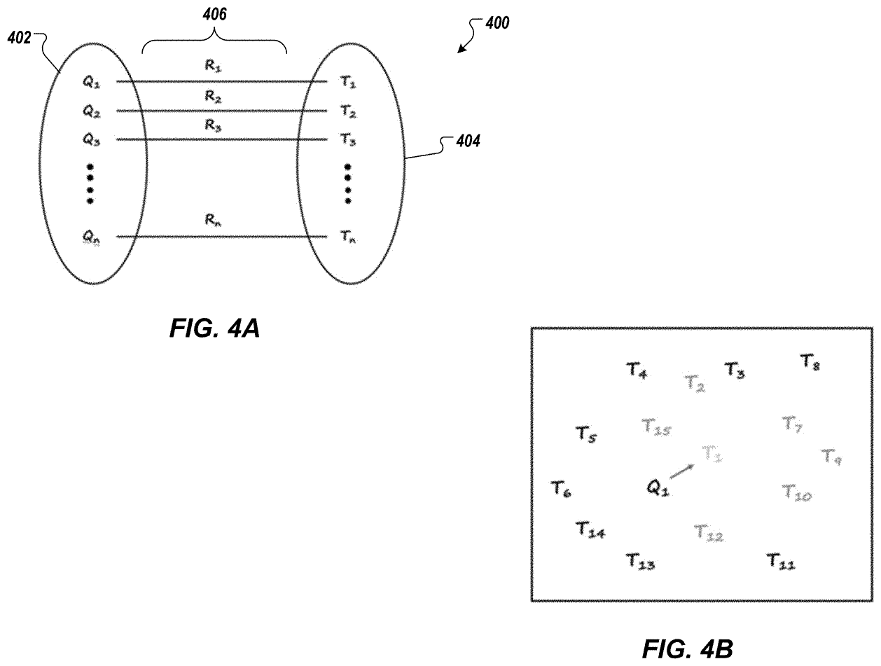

FIGS. 4A and 4B graphically depict use of anti-models in matching queries to targets using ML models in accordance with implementations of the present disclosure. More particularly, the example of FIGS. 4A and 4B represent matching a query (Q) to a target (T) based on a relation (R). FIG. 4A depicts an example training set 400 that includes a query entity set 402, a target entity set 404, and relations 406 therebetween. During the training phase, the training data 400 is used to learn a matching function (FM(Q, T)) for matching queries to targets based on the relations.

During runtime, the source model can propose a match between a query (Q1) and a target (T1). FIG. 4B depicts an example of hyperplane-transformed data points in a result set including a predicted match between the query (Q1) and the target (T1). In an example, the end user may believe that another target (T2) is the correct match for the query (Q1). In accordance with implementations of the present disclosure, an anti-model can be provided based on the alternative target (T2) to evaluate the source mode. As in the case of classification described above with reference to FIGS. 3A-3E, the anti-model approach includes mapping non-linear data to a linear data set using a hyper-plane transformation, defining a set of data points, constructing a simplex and a providing a simplex value (SM), providing a set of simplices based on a selected data point (e.g., the target (T2)), and determining an anti-model value (ϕ) to evaluate the reliability of the source model. That is, the above-described formulae are used to determine the source model value (SM), the anti-model sub-values (AM₁, . . . , AMₙ), and the anti-model value (ϕ).

As described herein, the anti-model value (ϕ) is evaluated to determine the reliability of the source model in view of the anti-model. For example, if the anti-model fails, which it is designed to do, it can be determined that the query (Q1) is properly not matched to the target (T2). Consequently, reliability of the source model is affirmed. On the other hand, if the anti-model does not fail, it can be determined that the target (T2) is a(nother) possible match to the query (Q1). Consequently, reliability of the source model is in doubt. This knowledge, that the specific target (T2) is another possible match, can be used for targeted re-training of the ML model. For example, the user can provide feedback to a training phase that the ML model should be adjusted to also select the target (T2) as a match for the query (Q1).

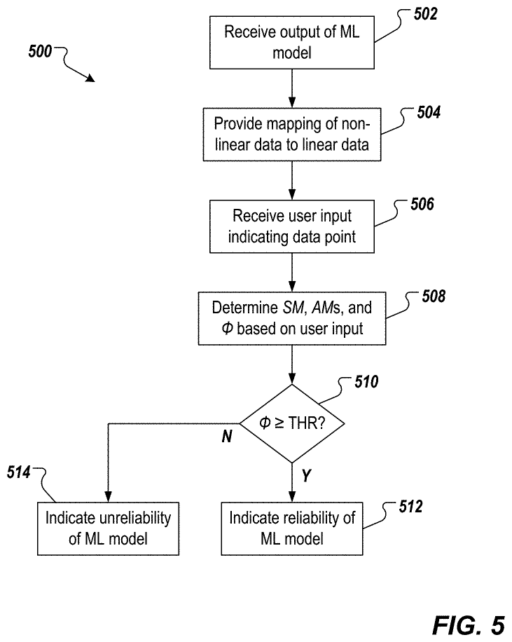

FIG. 5 depicts an example process 500 that can be executed in accordance with implementations of the present disclosure. In some examples, the example process 500 is provided using one or more computer-executable programs executed by one or more computing devices.

Output of a ML model is received (502). For example, a ML model is used to generate the output based on input. In some examples, the output can include classifications of entities (e.g., classifying an electronic document as either a bank statement or an invoice). In some examples, the output can include matches between entities (e.g., matching an electronic document representing a bank statement to an electronic document representing an invoice). A mapping of non-linear data to linear data is provided (504). For example, the output of the ML model can be provided in terms of a non-linear feature set. The output can be mapped using a mapping function to provide linear data.

User input indicating a data point is received (506). For example, user input can be received, which indicates a data point that the user is calling into question. In some examples, the data point can indicate a data point that the user may believe is improperly classified. In some examples, the data point can indicate a data point that the user may believe is a match to an entity that had not been matched to another entity. A source model value (SM), anti-model sub-values (AMs) and an anti-model value (ϕ) are determined (508). For example, and as described in detail above, a simplex (e.g., 2-simplex) is provided based on the source model and the source model value (SM) is calculated based thereon (e.g., as an area of the simplex). Also, an anti-model including a set of simplices is provided and anti-model sub-values (AMs) are calculated. As described herein, the anti-model value (ϕ) is determined based on the source model value, the anti-model sub-values and a function (fₓ).

It is determined whether the anti-model value (ϕ) is greater than or equal to a threshold value (THR) (510). An example threshold value can be provided as 0.95. If the anti-model value (ϕ) is greater than or equal to the threshold value (THR), a reliability of the ML model is indicated (512). For example, an output indicating that the anti-model failed is provided to represent that, for the data point selected by the user, the source model provided a correct classification or match. If the anti-model value (ϕ) is not greater than or equal to the threshold value (THR), an unreliability of the ML model is indicated (514). For example, an output indicating that the anti-model succeeded is provided to represent that, for the data point selected by the user, the source model provided an incorrect classification or missed a potential match. In some examples, an indication can be graphically depicted in a user interface (UI), through which a user interacts with a ML model platform in accordance with implementations of the present disclosure.

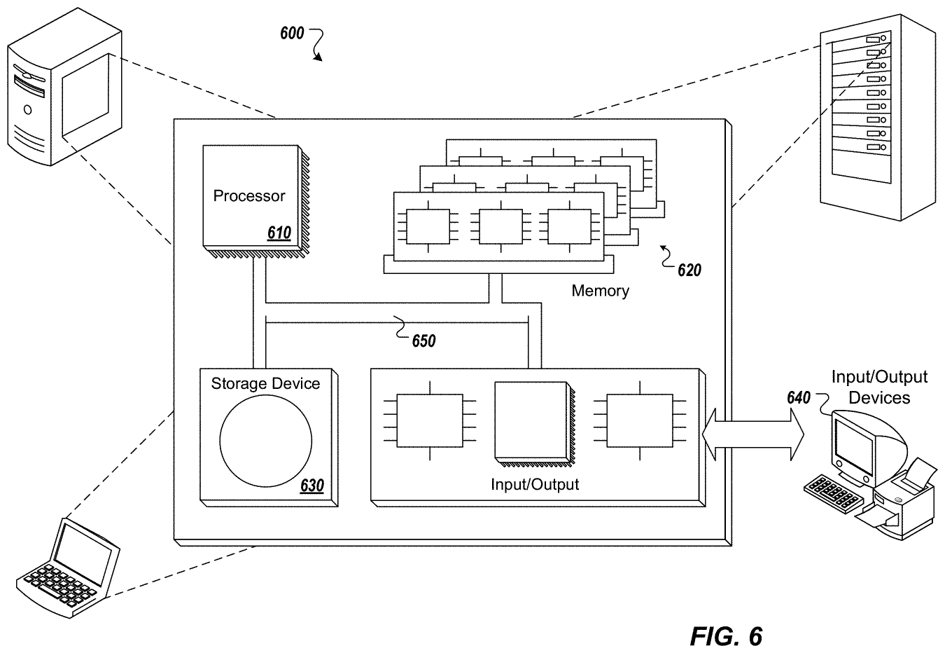

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing indications of reliability of predictions of machine learning (ML) models, the method being executed by one or more processors and comprising:
receiving user input indicating a first data point representative of output of a ML model;
calculating a source model value based on the first data point and a second data point;
calculating anti-model sub-values based on the first data point and a set of data points;
providing an anti-model value based on the source model value and the anti-model sub-values; and
determining a reliability of the output of the ML model based on the anti-model value.

2. The method of claim 1, wherein the source model value is calculated based on a simplex having vertices comprising the first data point, the second data point, and a third data point.

3. The method of claim 1, wherein the anti-model sub-values are each calculated based on a respective simplex comprising the first data point, a third data point, and a respective data point in a set of data points.

4. The method of claim 3, wherein the set of data points is defined based on a distance between the first data point and the second data point.

5. The method of claim 1, further comprising mapping non-linear data provided from the ML model to linear data, the linear data comprising the first data point, the second data point, and data points in the set of data points.

6. The method of claim 1, wherein determining the reliability of the output of the ML model based on the anti-model value comprises indicating one of reliability and unreliability by comparing the anti-model value to a threshold value.

7. The method of claim 6, wherein the ML model is indicated as reliable with respect to the first data point, if the anti-model value is at least equal to the threshold value, and the ML model is indicated as unreliable with respect to the first data point, if the anti-model value is less than the threshold value.

8. A non-transitory computer-readable storage medium coupled to one or more processors and having instructions stored thereon which, when executed by the one or more processors, cause the one or more processors to perform operations for providing explanations for predictions of machine learning (ML) models, the operations comprising:
receiving user input indicating a first data point representative of output of a ML model;
calculating a source model value based on the first data point and a second data point;
calculating anti-model sub-values based on the first data point and a set of data points;
providing an anti-model value based on the source model value and the anti-model sub-values; and
determining a reliability of the output of the ML model based on the anti-model value.

9. The computer-readable storage medium of claim 8, wherein the source model value is calculated based on a simplex having vertices comprising the first data point, the second data point, and a third data point.

10. The computer-readable storage medium of claim 8, wherein the anti-model sub-values are each calculated based on a respective simplex comprising the first data point, a third data point, and a respective data point in a set of data points.

11. The computer-readable storage medium of claim 10, wherein the set of data points is defined based on a distance between the first data point and the second data point.

12. The computer-readable storage medium of claim 8, wherein operations further comprise mapping non-linear data provided from the ML model to linear data, the linear data comprising the first data point, the second data point, and data points in the set of data points.

13. The computer-readable storage medium of claim 8, wherein determining the reliability of the output of the ML model based on the anti-model value comprises indicating one of reliability and unreliability by comparing the anti-model value to a threshold value.

14. The computer-readable storage medium of claim 13, wherein the ML model is indicated as reliable with respect to the first data point, if the anti-model value is at least equal to the threshold value, and the ML model is indicated as unreliable with respect to the first data point, if the anti-model value is less than the threshold value.

15. A system, comprising:
a computing device; and
a computer-readable storage device coupled to the computing device and having instructions stored thereon which, when executed by the computing device, cause the computing device to perform operations for providing explanations for predictions of machine learning (ML) models, the operations comprising:
receiving user input indicating a first data point representative of output of a ML model;
calculating a source model value based on the first data point and a second data point;
calculating anti-model sub-values based on the first data point and a set of data points;
providing an anti-model value based on the source model value and the anti-model sub-values; and
determining a reliability of the output of the ML model based on the anti-model value.

16. The system of claim 15, wherein the source model value is calculated based on a simplex having vertices comprising the first data point, the second data point, and a third data point.

17. The system of claim 15, wherein the anti-model sub-values are each calculated based on a respective simplex comprising the first data point, a third data point, and a respective data point in a set of data points.

18. The system of claim 17, wherein the set of data points is defined based on a distance between the first data point and the second data point.

19. The system of claim 15, wherein operations further comprise mapping non-linear data provided from the ML model to linear data, the linear data comprising the first data point, the second data point, and data points in the set of data points.

20. The system of claim 15, wherein determining the reliability of the output of the ML model based on the anti-model value comprises indicating one of reliability and unreliability by comparing the anti-model value to a threshold value.
